(19) United States
(12) Patent Application Publication
(10) Pub. No.: US 2010/0264083 A1
(43) Pub. Date: Oct. 21, 2010

(54) METHOD AND APPARATUS FOR TREATING WASTE ACTIVATED SLUDGE

(76) Inventor: Mark G. Biesinger, Salt Lake City, UT (US)

Correspondence Address: HUSCH BLACKWELL SANDERS LLP, 4801 Main Street, Suite 1000, KANSAS CITY, MO, 64112, US

(21) Appl. No.: 12/427,405

(22) Filed: Apr. 21, 2009

(51) Int. Cl. C02F 11/02; C02F 3/30; C02F 3/12

(52) U.S. Cl. 210/622; 210/630; 210/626; 210/195.3

(57) ABSTRACT

In an activated sludge process for treating wastewater, waste activated sludge is directed to a digester and subjected to sequential aerobic, anoxic and anaerobic treatment. Internal recycling of sludge may be carried out. The oxidation reduction potential during the anoxic and anaerobic cycles is carefully managed so that there is a significant reduction in the quantity of sludge that must be disposed of.

### CROSS-REFERENCE TO RELATED APPLICATIONS

None.

### FIELD OF THE INVENTION

This invention relates generally to the field of wastewater treatment and more particularly to an activated sludge treatment process in which waste activated sludge is treated in an improved manner.

### BACKGROUND OF THE INVENTION

Wastewater has long been treated using activated sludge processes in which the influent is biologically treated in a basin to produce a mixed liquor. Clarification or another technique is used to separate the mixed liquor into a clear liquid effluent and a solid biomass which takes the form of activated sludge. The effluent is discharged, whereas part of the activated sludge is returned to the activated sludge basin in order to maintain a sufficient bacteria concentration for effective treatment of the influent.

The part of the activated sludge that is not return activated sludge is referred to as waste activated sludge. The waste activated sludge must be removed from the system and disposed of by incineration, deposit in a landfill, or in some other way such as use as fertilizer. Handling and disposal of waste activated sludge is a significant problem that makes it highly desirable to minimize the quantity of the waste activated sludge that is generated in a treatment plant. While various processes have been developed attempting to reduce the amount of waste activated sludge, they have not been wholly satisfactory.

Such processes are generally either a form of biological digestion or a mechanical process in which the cell tissue is physically ruptured. Mechanical methods have included high frequency sonic cell disruption and high pressure/shear cell destruction. Both of these methods require high capital expenditures and they are both subject to high energy requirements.

The most common biological process that attempts to achieve a low waste activated sludge yield involves use of a reactor known as an interchange reactor. The interchange reactor modifies the biological population spectrum from the activated sludge basin so that different organisms predominate. Treated sludge from the interchange reactor is added to the influent and introduced back into the activated sludge basin. Even though processes using interchange reactors can achieve improvement, there are significant drawbacks including the need for additional equipment, plumbing, pumps and instrumentation that call into question whether the benefits outweigh the added cost and complexity.

### SUMMARY OF THE INVENTION

In accordance with the present invention, both aerobic and anaerobic digestion techniques are used in a unique process that reduces the quantity of waste activated sludge by increasing the solids destruction compared to what is achieved by either aerobic or anaerobic methods alone. The waste activated sludge may be screened, alone or together with the return activated sludge. Aeration of the waste activated sludge is carried out in a digester and may be interrupted periodically for solids settling and the decanting of clear liquid.

Either in the same zone or a different zone or zones of the digester, subsequent anoxic and anaerobic conditions are cycled through in sequence, optionally followed by aeration. The anoxic treatment denitrifies nitrate that might be present due to the aerobic treatment. The anaerobic treatment results in liberation of biodegradable intracellular material and ammonia nitrogen as well as moderate acidification. Some of the aerobic cell tissue is converted to anaerobic organisms which yield a much reduced mass to further decrease the net amount of sludge. The aerobic and anaerobic treatments can be carefully managed using oxidation reduction potential measurements to create the optimum conditions for achieving minimum sludge quantities and other desired benefits.

Other and further objects of the invention, together with the features of novelty appurtenant thereto, will appear in the course of the following description.

### BRIEF DESCRIPTION OF THE SEVERAL VIEWS OF THE DRAWING

In the accompanying drawings, which form a part of the specification and are to be read in conjunction therewith in which like reference numerals are used to indicate like or similar parts in the various views:

FIG. 1 is a schematic diagram of a method and apparatus for treating waste activated sludge in accordance with one embodiment of the present invention;

FIG. 2 is a schematic diagram of a method and apparatus for treating waste activated sludge in accordance with a modified embodiment of the invention; and

FIG. 3 is a schematic diagram of a method and apparatus for treating waste activated sludge in accordance with another modified embodiment of the invention.

### DETAILED DESCRIPTION OF THE PREFERRED EMBODIMENTS

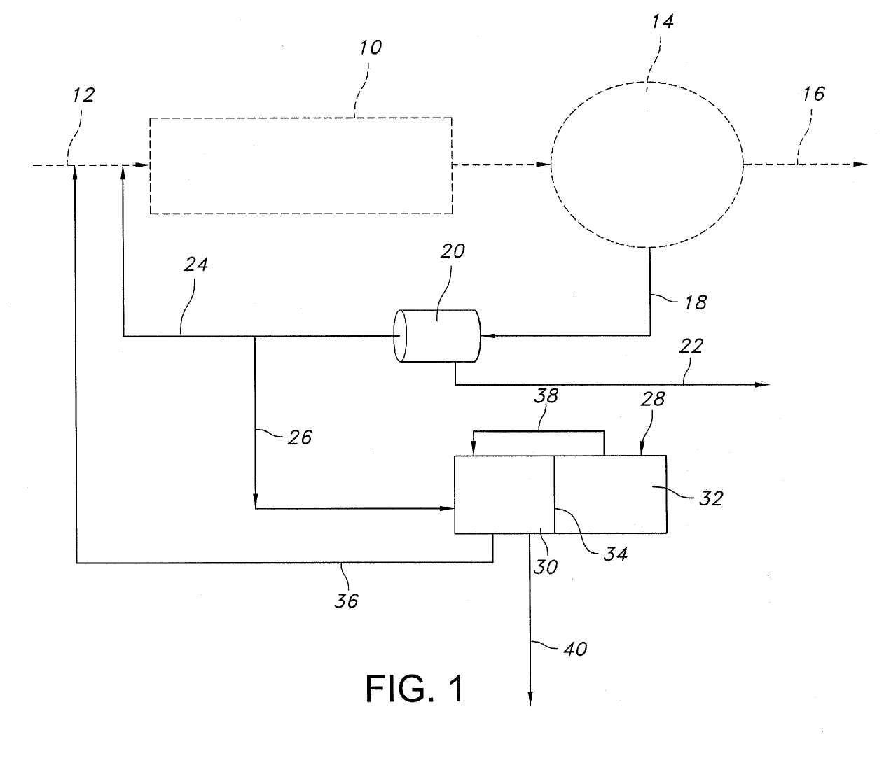

Referring now to the drawings in more detail and initially to FIG. 1, numeral 10 designates an activated sludge basin which receives wastewater influent along an influent line 12. In the basin 10, the wastewater is treated in accordance with conventional or advanced multi-stage activated sludge treatment processes. Mixed liquor that results from the process may be delivered to a clarification means 14 (such as a sedimentation basin, flotation basin or membrane) in which the mixed liquor is separated into a liquid effluent which is discharged on an effluent line 16 and activated sludge which is discharged from the clarification means 14 on line 18.

The sludge on line 18 may be passed through a screen 20 having screen openings that may range from 0.02 inch to 0.08 inch. The screen material can be wedge wire, woven mesh, perforated plate or any other suitable material. Larger solid materials that are removed by the screen 20 are discharged as trash on line 22. The sludge that passes through the screen 20 is separated into return activated sludge and waste activated sludge. The return activated sludge is delivered on line 24 to the influent line 12 and is thus recycled into the activated sludge basin 10 to maintain the proper concentration of bacteria needed for the activated sludge process. The waste activated sludge is delivered on line 26 to a digester 28. It should be noted that only the waste activated sludge may be screened, although it is usually preferred that both the return sludge and the waste sludge be passed through the screen 20.

The digester 28 may be divided into two or three stages such as zones 30 and 32 which may be separated by a partition 34 or in some other manner. The waste activated sludge that is delivered to the digester 28 on line 26 is first treated aerobically in zone 30. Conventional aerators (not shown) may operate in zone 30 to provide the aeration. Preferably, the dissolved oxygen concentration in zone 30 is maintained at a level equal to or greater than 0.5 mg/l for the majority of the time during the aeration stage of the process. The aeration in zone 30 can be interrupted periodically to allow for solids settling for thickening and concentration of the sludge, along with decanting. Clear supernatant water that is decanted in zone 30 may be delivered on line 36 to the influent line 12 and then into the activated sludge basin 10. After an appropriate period of time (which may range from a few hours to several days) of retention time in the aerobic stage 30, the sludge is then transferred into zone 32 of the digester 28. This transfer of the waste activated sludge may be carried out either on a batch basis or continuously.

In zone 32, the waste activated sludge is subjected sequentially to treatment under anoxic conditions, then under anaerobic conditions, and then optionally under aerobic conditions. The principal purpose of the anoxic cycle of treatment is to denitrify any nitrate that may be transferred from zone 30 into zone 32. During the anoxic period of treatment, the oxidation reduction potential is maintained in a range of about +50 MV to about −200 MV. The anoxic portion of treatment can be a separate zone.

In the subsequent anaerobic treatment cycle, the oxidation reduction potential is allowed to drop below about −200 MV and is preferably maintained in the range of approximately −200 MV to approximately −400 MV. During the anaerobic treatment, lyses and hydrolysis of cell tissue occurs, liberating biodegradable intracellular material. These reactions also liberate ammonia nitrogen. Although moderate acidification also occurs, no significant reduced sulfur compounds are produced. Some of the aerobic cell tissue is converted to anaerobic organisms which have a much lower mass yield in order to further reduce the net quantity of sludge. In addition, the anaerobic zone promotes phosphorus release by phosphorus accumulating organisms (PAOs) and encourages subsequent luxury phosphorus uptake upon return to the aerobic zone of the digester, resulting in a supernatant low in phosphorus, which is important for biological nutrient removal (BNR) processes. After the oxidation reduction potential reaches the selected lower limit (−400 MV, for example), the sludge in zone 32 may be aerated to minimize the production of objectionable odors.

A recycle line 38 is provided to recycle sludge from zone 32 back to zone 30. The recycled sludge which passes through line 38 returns soluble biodegradable cell material and ammonia nitrogen to the aerobic zone 30 where nitrification and further degradation take place. Sludge may be removed from the digester 28 and discharged from the treatment facility from either zone 30 or 32, such as along line 40.

Control of the aerobic/anoxic/anaerobic conditions can be either manual or automatic. The infeed, settling, decanting, intradigester sludge transfer and waste sludge discharge can be controlled either manually or automatically as well. Along with effective screening of the sludge, the amount of waste activated sludge that must be handled and disposed of can be reduced by 50% to 80% compared to conventional practice.

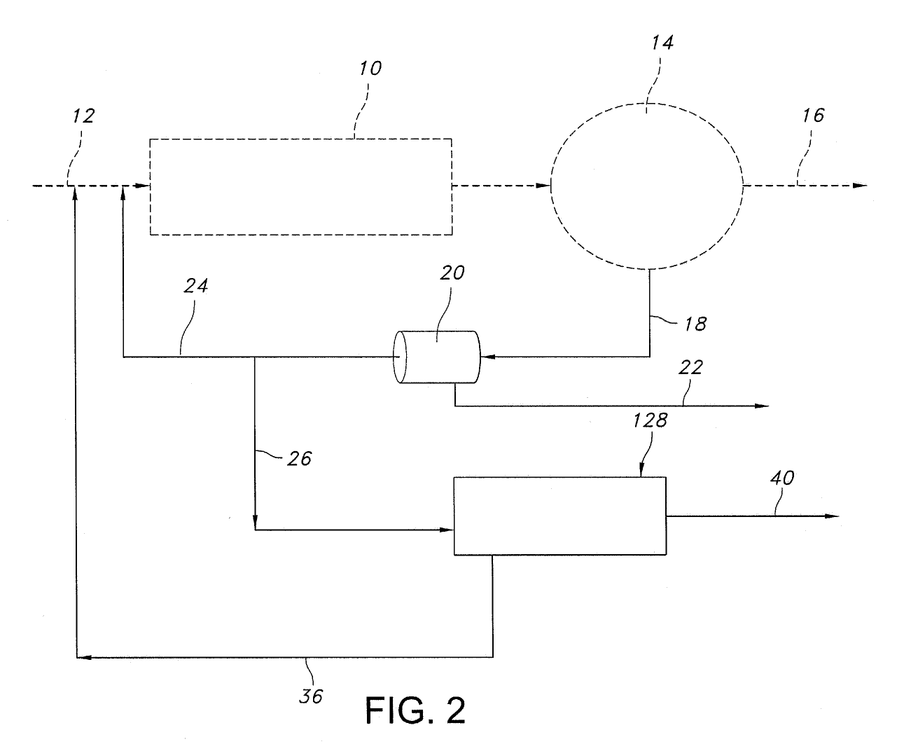

FIG. 2 depicts an alternative embodiment of the invention in which most of the process is identical to the process of FIG. 1. The components of the system of FIG. 2 are for the most part the same as in the embodiment of FIG. 1 and are identified by the same reference numerals.

The principal difference in the embodiment of FIG. 2 is that a digester 128 is used that has a single stage rather than being partitioned into two separate zones as is the case with digester 28 in the embodiment of FIG. 1. During operation of the system shown in FIG. 2, the digester 128 is operated so that the conditions to which the waste activated sludge is subjected cycle sequentially through aerobic conditions, anoxic conditions, and anaerobic conditions. During these stages of the treatment of the waste activated sludge, the dissolved oxygen concentration is preferably about the same as in the case of the FIG. 1 embodiment during the aerobic treatment, and the oxidation reduction potential ranges set forth for the FIG. 1 embodiment are maintained in the treatment system of FIG. 2 for the anoxic and anaerobic stages of the treatment.

Because the embodiment of FIG. 2 uses a single stage digester 128, the reaction kinetics are somewhat slower than in the embodiment of FIG. 1 so the total tank volume is larger. The sludge quantity in the embodiment of FIG. 2 may be reduced by approximately 50%-70% compared to conventional practice.

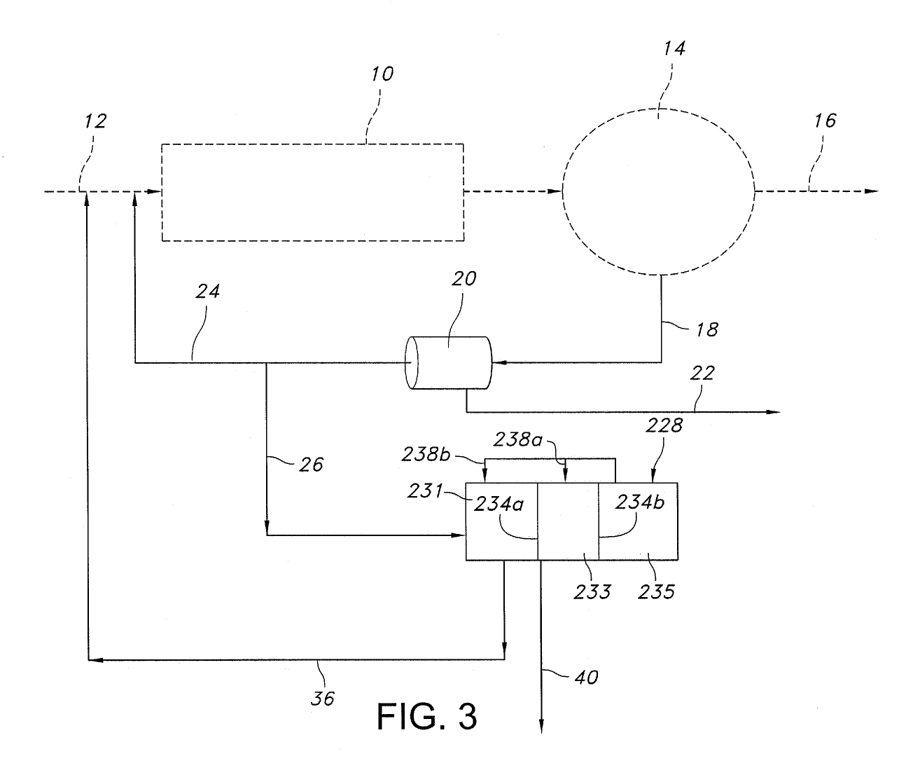

FIG. 3 depicts another embodiment of the invention in which most of the process is identical to the processes of FIGS. 1 and 2. The components of the system of FIG. 3 are for the most part the same as in the embodiments of FIGS. 1 and 2 and are identified by the same reference numerals.

The principal difference in the embodiment of FIG. 3 is that a digester 228 is used that has three separate stages, including an initial aerobic stage or zone 231, an anoxic stage or zone 233, and an anaerobic stage or zone 235, each of which is separate from the others. Zones 231 and 233 are separated by a partition 234a, and zone 233 is separated from zone 235 by another partition 234b. A recycle line 238a provides for recycling of sludge from zone 235 to zone 233. Sludge from either or both of zones 233 and 235 may be recycled to zone 231 on another recycle line 238b.

During operation of the system shown in FIG. 3, the digester 228 is operated so that the conditions to which the waste activated sludge is subjected cycle sequentially through aerobic conditions in zone 231, anoxic conditions in zone 233, and anaerobic conditions in zone 235. During these stages of the treatment of the waste activated sludge, the dissolved oxygen concentration is preferably about the same as in the case of the FIG. 1 embodiment during the aerobic treatment, and the oxidation reduction potential ranges set forth for the FIG. 1 embodiment are maintained in the treatment system of FIG. 3 for the anoxic and anaerobic stages of the treatment in zones 233 and 235, respectively. The embodiment of FIG. 3 has the advantage that the environment in each zone is maintained rather than being cycled through different conditions.

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

What is claimed is:

1. In an activated sludge treatment process using a reactor that produces return activated sludge which is returned to the reactor for use in the activated sludge treatment process and waste activated sludge which is removed for disposal, a method of treating said waste activated sludge comprising:
(a) subjecting the waste activated sludge to aerobic conditions for a selected time;
(b) thereafter subjecting the waste activated sludge to anoxic conditions for a selected time;
(c) thereafter subjecting the waste activated sludge to anaerobic conditions for a selected time; and
(d) discharging sludge resulting from steps (a)-(c).

2. A method as set forth in claim 1, wherein step (a) is effected in a first zone and steps (b) and (c) are effected in a second zone separate from said first zone.

3. A method as set forth in claim 2, including the step of recycling sludge from said second zone to said first zone.

4. A method as set forth in claim 2, wherein said first and second zones are located in a multi-stage vessel.

5. A method as set forth in claim 1, wherein the dissolved oxygen concentration is maintained at a level of at least about 0.5 mg/l for the majority of the time step (a) is being effected.

6. A method as set forth in claim 1, wherein the oxidation reduction potential is between about +50 MV and about −200 MV during step (b).

7. A method as set forth in claim 6, wherein the oxidation reduction potential is between about −200 MV and about −400 MV during step (c).

8. A method as set forth in claim 1, wherein the oxidation reduction potential is between about −200 MV and about −400 MV during step (c).

9. A method as set forth in claim 1, wherein steps (a)-(c) are all effected in a common zone.

10. A method as set forth in claim 1, including the step of screening the waste activated sludge prior to step (a).

11. A method as set forth in claim 1, wherein step (a) is effected in a first zone, step (b) is effected in a second zone separate from said first zone, and step (c) is effected in a third zone separate from said first and second zones.

12. A method as set forth in claim 11, wherein said first zone, said second zone and said third zone are all located in a multi-stage vessel.

13. An activated sludge process for treating influent, comprising:
directing the influent into a primary reactor in which effluent and sludge are produced;
directing a portion of the sludge produced in said reactor back into the reactor as return sludge;
directing another portion of the sludge produced in said reactor into a digester vessel as waste activated sludge;
subjecting the waste activated sludge to aerobic conditions for a selected time at a dissolved oxygen level above a selected level for the majority of said selected time;
thereafter subjecting the waste activated sludge to anoxic conditions for a selected time at an oxidation reduction potential having a first range;
thereafter subjecting the waste activated sludge to anaerobic conditions for a selected time at an oxidation reduction potential having a second range lower than said first range;
returning supernatant liquid from said digester vessel to said reactor;
discharging sludge from said digester vessel.

14. A process as set forth in claim 13, wherein said step of subjecting the waste activated sludge to aerobic conditions is effected in a first zone of said digester vessel and said steps of subjecting the waste activated sludge to anoxic conditions and to anaerobic conditions are effected in a second zone of said digester vessel separate from said first zone.

15. A process as set forth in claim 14, including the step of recycling sludge from said second zone to said first zone.

16. A process as set forth in claim 13, wherein said selected level is about 0.5 mg/l.

17. A process as set forth in claim 16, wherein said first range is from about +50 MV to about −200 MV.

18. A process as set forth in claim 16, wherein said second range is from about −200 MV to about −400 MV.

19. A process as set forth in claim 13, wherein said first range is from about +50 MV to about −200 MV.

20. A process as set forth in claim 19, wherein said second range is from about −200 MV to about −400 MV.

21. A process as set forth in claim 13, wherein:
said step of subjecting the waste activated sludge to aerobic conditions is effected in a first zone of said digester vessel;
said step of subjecting the waste activated sludge to anoxic conditions is effected in a second zone of said digester vessel separate from said first zone; and
said step of subjecting the waste activated sludge to anaerobic conditions is effected in a third zone of said digester vessel separate from said first and second zones.

22. In an activated sludge treatment system which produces clarified effluent and sludge, the improvement comprising:
a return sludge line arranged to return a first portion of said sludge to the activated sludge treatment system;
a waste sludge line arranged to receive a second portion of said sludge as waste activated sludge;
a digester connected to said waste sludge line to receive said waste activated sludge therefrom;
means for effecting aerobic treatment of said waste activated sludge in said digester;
means for effecting anoxic treatment of said waste activated sludge in said digester following said aerobic treatment;
means for effecting anaerobic treatment of said waste activated sludge in said digester following said anoxic treatment;
a supernatant return line for directing supernatant liquid from said digester to said activated sludge treatment system; and
a waste sludge disposal line for discharging digested sludge from said digester.

23. The improvement of claim 22, wherein said digester includes:
a first zone in which said aerobic treatment is effected; and
a second zone in which said anoxic treatment and said anaerobic treatment are effected.

24. The improvement of claim 23, including a recycle line extending from said second zone to said first zone for recycling of sludge therebetween.

25. The improvement of claim 22, including a screen for screening sludge delivered to said digester from the activated sludge treatment system.

26. The improvement of claim 22, wherein the dissolved oxygen concentration is at least about 0.5 mg/l during the majority of said aerobic treatment.

27. The improvement of claim 22, wherein the oxidation reduction potential is between about +50 MV to about −200 MV during said anoxic treatment.

28. The improvement of claim 27, wherein the oxidation reduction potential is between about −200 MV and about −400 MV during said anaerobic treatment.

29. The improvement of claim 22, wherein said digester includes:
a first zone in which said aerobic treatment is effected;
a second zone in which said anoxic treatment is effected; and
a third zone in which said anaerobic treatment is effected.

30. An activated sludge treatment apparatus for treating wastewater, comprising:
a primary reactor arranged to receive the wastewater and to produce effluent and sludge;
an effluent discharge line for receiving and discharging the effluent;
a return sludge line for returning a first portion of the sludge to said primary reactor;
a waste sludge line for receiving a second portion of the sludge as waste activated sludge;
a digester arranged to receive said waste activated sludge from said waste sludge line and to operate in an aerobic mode to treat said waste activated sludge under aerobic conditions, in an anoxic mode subsequent to said aerobic mode to treat said waste activated sludge under anoxic conditions, and in an anaerobic mode subsequent to said anoxic mode to treat said waste activated sludge under anaerobic conditions;
a supernatant return line arranged to direct supernatant liquid from said digester to said primary reactor; and
a waste sludge disposal line for discharging digested sludge from said digester.

31. Apparatus as set forth in claim 30, wherein said digester includes:
a first zone in which treatment in said aerobic mode is effected; and
a second zone in which treatment in said anoxic mode and said anaerobic mode are effected.

32. Apparatus as set forth in claim 31, including a recycle line for recycling sludge from said second zone to said first zone.

33. Apparatus as set forth in claim 30, wherein said anoxic mode is operated at an oxidation reduction potential in the range of about +50 MV to about −200 MV.

34. Apparatus as set forth in claim 33, wherein said anaerobic mode is operated at an oxidation reduction potential in the range of about −200 MV to about −400 MV.

35. Apparatus as set forth in claim 30, wherein said digester includes:
a first zone in which treatment in said aerobic mode is effected;
a second zone in which treatment in said anoxic mode is effected; and
a third zone in which treatment in said anaerobic mode is effected.
